(19) United States
(12) Patent Application Publication
(10) Pub. No.: US 2007/0262874 A1
(43) Pub. Date: Nov. 15, 2007

(54) Systems and Methods for Tagging, Tracking, Targeting, and Termination of Mobile Targets

(75) Inventors: Theodore Sumrall, Fort Walton Beach, FL (US); Richard Schaller, Niceville, FL (US)

Correspondence Address: SUTHERLAND ASBILL & BRENNAN LLP, 999 PEACHTREE STREET, N.E., ATLANTA, GA, 30309, US

(73) Assignee: Schaller Engineering, Inc., Niceville, FL (US)

(21) Appl. No.: 11/379,652

(22) Filed: Apr. 21, 2006

(51) Int. Cl. G08B 13/14; G08B 1/08

(52) U.S. Cl. 340/572.8; 340/539.13

(57) ABSTRACT

A system for tagging and locating a target that may include a projectile frangible on impact, a RF tagging system located in the projectile, and a bonding agent located in the projectile for bonding the RF tagging system to the target. The RF tagging system may include a RF circuitry, an antenna, and a power source to transmit the location of the RF tagging system.

### RELATED APPLICATION

The present application claims priority to provisional application Ser. No. 60/477,467 entitled Systems and Methods for Tagging, Tracking, Targeting, and Termination of Mobile Targets, filed on Apr. 13, 2006.

### STATEMENT RGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Contract No. FO8630-03-M-0162 awarded by the U.S. Department of Defense.

### FIELD OF THE INVENTION

The present invention relates to locating mobile targets, and more particularly, the present invention relates to an improved system for tagging, tracking, targeting and termination (T⁴) of mobile targets.

### BACKGROUND OF THE INVENTION

There is a need in the art for a real-time integration of command and control, intelligence, surveillance, and reconnaissance (C4ISR) and attack functions at a target. The current targeting and attack process is dependent on coordination through the Air Operations Center or an equivalent controlling agency. This off-target coordination requires time-consuming communications that could allow the target to escape and (in the case of a very lethal target such as an mobile Intercontinental Ballistic Missiles) allow the target sufficient time to launch its weapons prior to destruction. Currently, target selection requires a significant period of time and a significant amount of resources. This is particularly difficult and laborious (and more often than not, unsuccessful) in the case of mobile targets. A few examples of how this is currently accomplished follows:

1) Forward Air Control (FAC) Mobile Target Identification: A forward air controller will identify targets within a general area and report the target types, general location, bearing and heading back to the Air Operations Center. The Air Operations Center will determine if the targets warrant destruction and if so, will order an air strike via the most effective assets within the general target area. The strike leader then proceeds to the general vicinity of the target based upon original target information and any updated target location information. The strike team then begins a search pattern in order to locate and confirm the target. This process is frequently unsuccessful due to a number of factors (i.e. time between target reporting and strike sortie, weather, time of day, and target directional changes since last known sighting, etc.) and also causes the strike team to be subjected to a significant level of risk as they engage in a predictable and time consuming search pattern which could allow enemy surface-to-air missiles to engage the strike team due to increased loiter time. Additionally, target confirmation is also a difficult process, and at night is even more difficult. Once the target is identified, then the strike team employs weapons which are suited for the task, generally more expensive/standoff weapons unless visual identification is easy and no known threats are in the area. Frequently, however, conditions cause the aircraft to come within range of enemy anti-aircraft weapons.

2) Non-Mobile Target Identification—Frequently non-mobile targets are selected based upon satellite (or reconnaissance aircraft) imagery, however, this has its limitations and often ground assets are required for target confirmation. Even in the case of non-mobile targets, the target may not be destroyed or the wrong target destroyed because the technique used to locate the intended target may be severely flawed. In an effort to pinpoint the location of the target land navigation techniques have been employed. These techniques, called ‘intersection’ and ‘resection’, are only adequate to provide a general location and are not accurate enough to provide the actual location required for aerial targeting. As a result, targets may be mistakenly identified, when in fact, its actual whereabouts may be thousands of feet away.

Therefore, there is a need in the art for a system and method for remote tagging, tracking, and targeting of target locations and a more rapid, precise, safer, inexpensive and less complex method of mobile target termination. There is also a need for the ability to precisely tag non-mobile targets to decrease the likelihood of accidental destruction of the wrong target.

### BRIEF SUMMARY OF THE INVENTION

One embodiment of the present invention provides a system for tagging and locating a target. The system includes a projectile frangible on impact, a RF tagging system located in the projectile, and a bonding agent located in the projectile. The RF tagging system may include a RF circuitry, an antenna, and a power source. The RF circuitry may include a circuit board, a processor, and a resonator. The antenna may be a dipole antenna. The bonding agent may include polybutene or polyisobutene.

In another aspect of the invention, the projectile includes a cover that forms a distal end of the projectile. The cover may be scored to enable the cover to be frangible upon impact of the cover with the target. In another aspect of the invention, the RF tagging system includes a reflective circuitry, that enables the RF tagging system to be selectively powered on and off. The selectively powering on and off through the reflective circuitry may be accomplished through a radar transmission. In yet another aspect of the invention, a GPS device may be used to determine the location of the system. The location may be determined by the GPS device through transmission through the antenna to a cellular phone tower for transmission to a cellular phone receiver. In yet another aspect, the RF tagging system transmits a signal to at least three cellular towers to determine the location of the RF tagging system. In yet another aspect of the invention, the RF tagging system and bonding agent are delivered to the target using a delivery device, such as a gun.

Another embodiment of the invention provides a method for tagging and locating a target including the steps of providing a RF tagging system, providing a bonding agent for affixing the RF tagging system to the target, and inserting the RF tagging system and the bonding agent into a projectile for transporting the RF tagging system and bonding agent.

Another embodiment of the invention provides a system for tagging and locating a target that includes a RF tagging system, wherein the RF tagging system comprises RF circuitry, antenna, and power source, a bonding agent for affixing the RF tagging system to the target, a GPS receiver for determining the location of the tagging system, and a projectile for containing and transporting the RF tagging system, bonding agent, and GPS receiver, wherein the projectile is frangible on impact.

Yet another embodiment of the invention provides a system for tagging and locating a target that includes a RF tagging system, wherein the RF tagging system comprises RF circuitry, antenna, and power source, a bonding agent for affixing the RF tagging system to the target, a GPS receiver for determining the location of the RF tagging system, and a projectile for containing and transporting the RF tagging system, bonding agent, and GPS receiver, wherein the projectile is manually affixed to the target.

### BRIEF DESCRIPTION OF THE DRAWINGS

FIG. 1 is a drawing illustrating the RF system and projectile.

FIG. 2 illustrates the delivery of the RF system to a target.

FIG. 3 illustrates scoring of the projectile.

FIG. 4 illustrates the use of reflective circuitry to control the RF system.

FIG. 5 illustrates locating the RF system using a GPS receiver.

### DETAILED DESCRIPTION OF THE INVENTION

The present invention now will be described more fully hereinafter with reference to the accompanying drawings, in which exemplary embodiments of the invention are shown. This invention may, however, be embodied in many different forms and should not be construed as limited to the embodiments set forth herein; rather, these embodiments are provided so that this disclosure will be thorough and complete, and will convey the scope of the invention to those skilled in the art.

The present invention includes systems and methods for tagging a target for subsequent locating through the use of a radio frequency system (“RF tagging system”). The tagging also may be used to prepare a battlefield in advance for an attack force by enabling both tactical level command , control, communication, computer, intelligence, surveillance, and reconnaissance (“C4ISR”) platforms and attack platforms to share the same source of real-time target location information. The RF tagging system may form the common operating picture key to time-critical-targets and precision strike by providing location information of a target based upon real-time precision location of time-critical-targets. A target set may include a static or a mobile target, such as a truck, tank, scud, other vehicle, or missiles or even individual/multiple enemy personnel who are tagged.

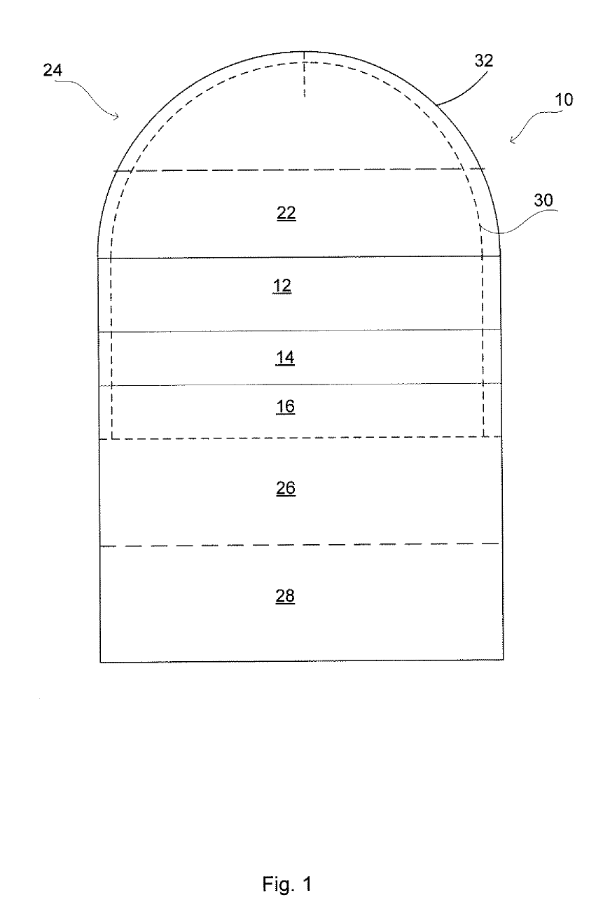

As illustrated in FIG. 1, the RF tagging system I0 may be used to transmit the time and positional information of a target. The RF tagging system 10 may include at least one microelectronic device used to locate and transmit coordinates of the RF tagging system 10. The RF tagging system 10 may include RF circuitry 12, an antenna 14, and a power source 16 integrated with a transceiver. The RF circuitry 12 also may include a circuit board, a processor, a resonator, or any other circuitry to process for the RF tagging system 10. In an exemplary embodiment, the RF circuitry 12 includes a fully integrated voltage-controlled oscillator, a divided-by-32 divider, a phase-frequency detector and a charge pump. An internal loop filter may be used to determine the dynamic behavior of the Phase-Locked Loop and may suppress reference spurious signals. A Colpitts crystal oscillator may be used as a reference oscillator of a phase-locked loop synthesizer. The voltage-controlled oscillator output signaling may be used to feed a power amplifier for the RF circuitry. The RF circuitry 12 of the exemplary embodiment may be an integrated circuit manufactured by Melexis Corporation. One of ordinary skill in the art will appreciate that the RF circuitry 12 is not limited to the above specification or the Melexis Corporation RF circuitry but may include any capabilities and design that adequately allows the RF tagging system 10 to transmit its location.

The RF circuitry 12 may create an RF signal that has a RF signal power which is transmitted through the antenna 14. The antenna 14 included in the RF tagging system 10 may be of any configuration that permits transmission from its location. In an exemplary embodiment, the antenna 14 is a dipole antenna. In the exemplary embodiment, the antenna has a one quarter inch wavelength dipole. The present invention is not limited to dipole antennas but may include any antenna configuration including logarithmic antennas.

The power source 16 included in the RF tagging system 10 is used to power the system. The power source 16 may be any source that provides sufficient power to operate the RF circuitry and antenna, such as a battery or a thermoelectric device. In an exemplary embodiment, the power source is at least one button battery. One of ordinary skill in the art will appreciate that any battery may be used herein.

The RF tagging system 10 may be miniaturized so as to be covert to limit detectability of the RF tagging system 10 when attached to the target. In an exemplary embodiment, the RF circuitry 12 measures approximately 1.2 millimeters in diameter. One of ordinary skill in the art will appreciate that the RF circuitry 12 may be any size and is not limited to the embodiment illustrated herein. In another exemplary embodiment, the RF circuitry 12, antenna 14, and the power source 16 are collectively approximately 9 millimeters by 9 millimeters. One of ordinary skill in the art will appreciate that the RF tagging system 10 is not limited to the sizes described herein but may be of any dimension suitable to track a target of interest. Furthermore, the RF tagging system 10 may be a single device wherein the RF circuitry 12, antenna 14, and power source 16 are integrated. One of ordinary skill in the art will appreciate that the RF tagging system 10 may be one device or any number of devices combined for operation.

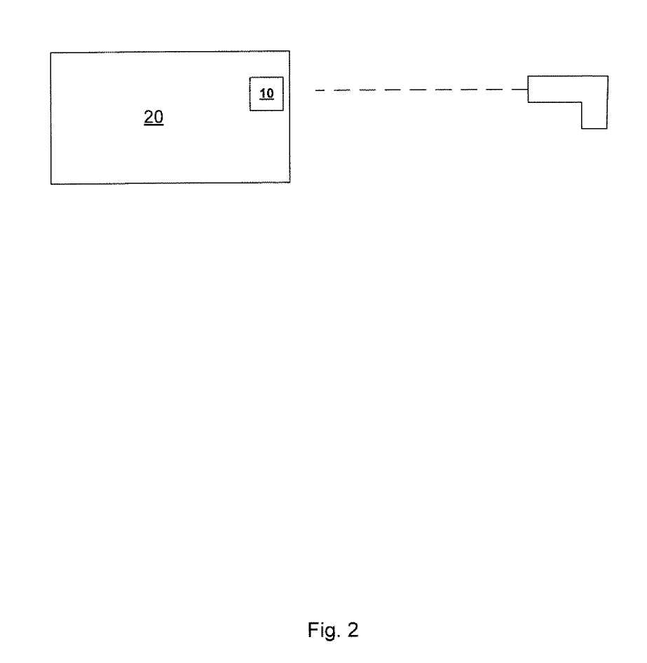

As illustrated in FIG. 2, in order to prepare the battlefield, the RF tagging system 10 is delivered to a target 20. When a target has a RF tagging system 10 attached thereto, the target 20 has been “tagged.” The target 20 may be tagged in any manner that allows the RF tagging system 10 to sufficiently adhere to the target 20. For instance, the RF tagging system 10 may be attached to the target 20 using a bonding agent 22. The bonding agent 22 may be any adhesive material including glue, glass glue, liquid nails, or any other adhesive agent.

The RF tagging system 10 and bonding agent 22 may be inserted into a projectile 24 for delivery of the device to a target 20. The projectile 24 may be of any configuration that allows delivery of the projectile 24 to the target 20. For instance, in an exemplary embodiment, the projectile 24 may be any caliber projectile such as a 22 caliber, 0.45 caliber, 9 mm or any other caliber projectile and is not limited to use with 0.45 caliber weaponry. The projectile 24 may be fired from any standard gun or any other specially designed device that can deliver the projectile 24 to the target 20. The projectile 24 when fired will maintain its orientation during flight to the target 20 and impact with the tip of the projectile.

In an exemplary embodiment, the projectile 24 is a 0.45 caliber gun delivery system that attaches the RF tagging system 10 to the target 20. The 0.45 caliber is a common weapon with sufficient power to attach the RF tagging system 10 on the target 20. The 0.45 caliber round maintains its orientation during flight to the target 20 and impacts with a predictable orientation ensuring that the bonding agent 22 impacts first and the antenna 14 remains exposed. One of ordinary skill in the art will appreciate that the RF tagging system 10 may be delivered by any ballistic system including any caliber projectile. However, for illustrative purposes only, the 0.45 caliber projectile and gun will be used as examples throughout the remainder of this application.

The RF tagging system 10 may be packaged into a projectile 24 for delivery to the target. The package may include the RF tagging system 10, wadding 26, and propellant 28, The RF tagging system 10, wadding 26 and propellant 28 may be enclosed in a encasing 30. In an illustrative embodiment, the encasing 30 is made of aluminum, however any metal or other non-conductive material is contemplated herein. The encasing 30 may also be any shape. In an illustrative embodiment, the encasing 30 is cylindrically shaped.

The wadding 26 may be used as a space filler in the encasing 30 which also effects the distance and accuracy of the projectile 24. The wadding 26 may be cad fiber or any other material that may be packed into the encasing 30. The amount of wadding 26 may affect the flight of the projectile 24 of which the encasing 30 is incorporated into. For instance, in an exemplary embodiment, a 2 gram wadding 26 in a 0.45 caliber projectile may allow the projectile 24 to travel approximately 50 yards. On the other hand, 4 grams of wadding may allow the projectile 24 to fly 100 yards. Furthermore, the density of the wadding 26 may be altered to affect the accuracy of the projectile 24. For instance, as one of ordinary skill in the art would appreciate, the more the wadding 26 is compacted, the greater the accuracy of the projectile 24.

The encasing 30 encloses the RF tagging system 10 and wadding 26 and secures it in the projectile 24. The encasing 30 may not be required if the RF tagging system 10 does not need to be secured together. For example, if the RF tagging system 10 consists of only one device, the encasing 30 may not be needed. However, if the RF tagging system 10 consists of multiple devices such that the RF circuitry 12, power source 16, and antenna 14 are separate devices, the encasing 30 may be required to secure the devices together for operation.

The projectile 24 may include a cover 32 that may be placed about the encasing 30 to form the tip of the projectile. The cover 32 may be any material that is frangible upon impact. In an exemplary embodiment, the cover 32 is made of plastic. The cover 32 is dimensioned to fit sufficiently in the barrel of the delivery device. For example, if the delivery device is a 0.45 caliber gun, the cover 32 is dimensioned such that the projectile is a 0.45 caliber projectile. One of ordinary skill in the art will appreciate that any caliber projectile is contemplated herein. The cover 32 also may be aerodynamically designed to ensure that the projectile 24 maintains its orientation during flight.

The projectile 24 may be placed into a shell for firing. A standard shell for the 0.45 caliber example, may be a cylindrically shaped brass shell. One of ordinary skill in the art will appreciate that any shell is contemplated herein. Propellant 28 may be inserted behind the encasing 30 to propel the projectile 24 upon firing. One of ordinary skill in the art would appreciate that any propellant such as gun powder may be used to fire the projectile 24. Below the propellant may be a secondary wadding 26 used to fill the projectile space in the shell. One of ordinary skill in the art will appreciate that the propellant and secondary wadding 26 may be enclosed by the shell. Upon firing of the projectile 24, the bonding agent 22, the RF tagging system 10 and wadding 26 are expelled from the gun barrel toward the target 20.

Delivery

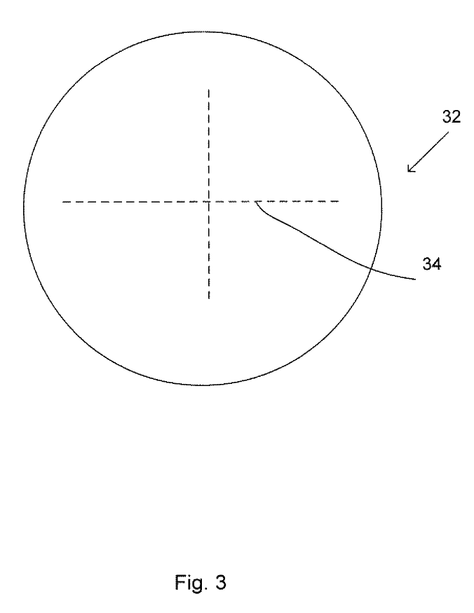

As illustrated in FIG. 3, the cover 32 may include scorings 34 to allow the tip of the projectile to be frangible upon impact of the target 20. The scoring may include a simple cross, pie, single slit, multiple slits or conical score. One of ordinary skill in the art will appreciate that any score may be used that allows the tip of the projectile to sufficiently break on impact to allow the RF tagging system 10 to attach to the target 20.

Upon breaking of the projectile, the bonding agent 22 becomes exposed to the target 20. The bonding agent 22 adheres to the target 20 thereby attaching the RF tagging system 10 to the target 20. In an alternative embodiment, the RF tagging system 10 may be manually affixed to the target 20 by human placement, robotic placement, or any other manner of placement. In another exemplary embodiment, the RF tagging system 10 may be placed by a micro-aircraft. For example, the micro-aircraft carrying the RF tagging system may be flown into a hostile area and shoot the RF tagging system at the target 20.

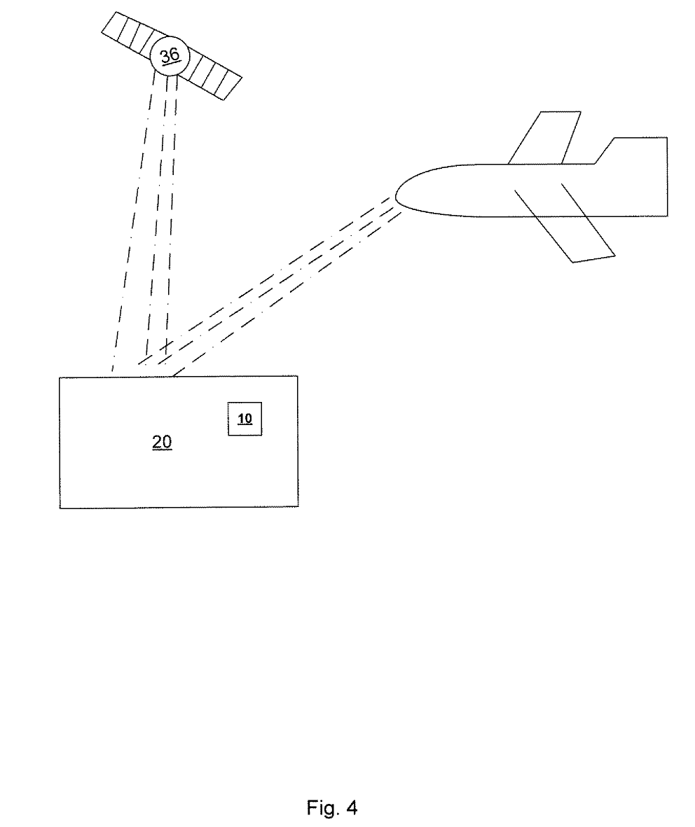

The RF tagging system 10 may be powered on upon impact through an inertial switch. As illustrated in FIG. 4, to conserve power, the RF tagging system 10 may be activated remotely using reflective circuitry. As one of ordinary skill in the art will appreciate, reflective circuitry may use any power source to switch the device on, such as power from a radar. Accordingly, the reflective circuitry may be scanned by a radar when use is desired to activate the reflective circuitry. Remote powering of the RF tagging system 10 through reflective circuitry conserves the life of the power source of the RF tagging system 10 because it is only powered on when desired. For example, in an exemplary embodiment the power source has a 1.8 volt power threshold and transmits for twelve hours continuously powered by a standard 3.0 volt watch battery. The duty cycle of the power source may be expanded by using the reflective circuitry to activate the device for pre-determined periods of operation. One of ordinary skill in the art will appreciate that the reflective circuit may operate in any frequency band including X, Ku, and Ka band.

The duration of the RF tagging system 10 on the target 20 may be extended through a reflective circuit that can be activated and interrogated at the tactical level by a radar gun or other energy transmitting devices. In an exemplary embodiment, a standard law enforcement radar gun may be used to activate the reflective circuit. In another embodiment, a radar from a military airborne C4ISR or attack platform may be used to activate the reflective circuit. One of ordinary skill in the art will appreciate that the invention is not limited to radar guns and may also include devices such as Global Hawk or reconnaissance satellites.

Location

After the target has been tagged with the RF tagging system 10, the RF tag needs to be located by tactical C42ISR or attack platforms.

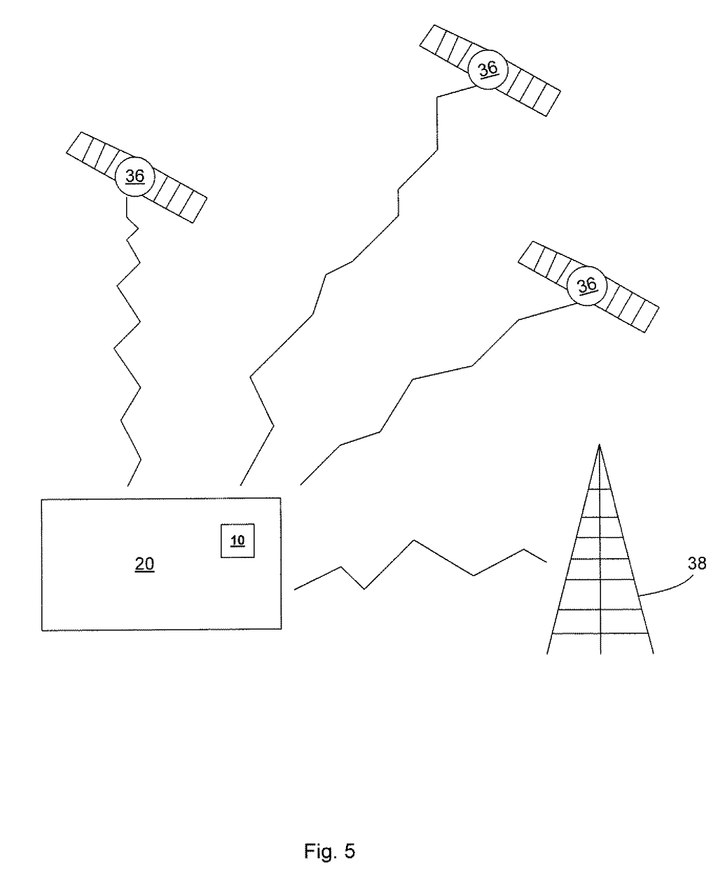

As illustrated in FIG. 5, in order to transmit the location of the RF tagging system 10, the RF circuitry 12 may include a miniature Global Positioning System (GPS) receiver. The RF tagging system 10 equipped with a GPS receiver has the capability to receive GPS signals from a GPS Satellite 36 and then transmit the UPS information to C4ISR or attack platforms. The RF tagging system 10 may use cellular phone technology to transmit the GPS location of the tag. The RF circuitry 12 can implement similar amplitude and frequency shift keys as the cellular phone technology. In an exemplary embodiment, the RF circuitry 12 with cellular phone technology can transmit data to the cellular towers 38. The cellular towers 38 may then transmit the GPS location of the target to a cellular receiver, such as C4ISR or attack platforms.

In one exemplary embodiment, GPS receivers are integrated into the RF tagging system 10 to receive the coordinates from the GPS satellite 36 and determine its location. In an exemplary embodiment, miniature UPS receivers measuring 4 millimeters by 4 millimeters are commercially available and can be integrated with the RF circuitry 12 to provide precise real-time geospatial information to both C4ISR and attack platforms.

In another exemplary embodiment, cellular phone technology may be used to locate its position by triangulating between at least three cellular phone towers 38. The RF tagging system 10 can transmit to the cellular phone towers 38 based on the RF tagging system's 10 relative location to each tower. Standard triangulation algorithms may be used to locate a global position of the RF tagging system 10 based on the distance between the RF tagging system's position relative to the towers 38. However, tag location may be determined through the use of only two or possibly one cellular tower 38 to locate the tag.

The RF tagging system may be used to track the target for better battlefield management. The RF tagging system also may be used to guide a munition during the flight and terminal phase of an attack. The target 20 location information may be transmitted to the munition and uploaded to the guidance and control system. Based on the real-time target location, the guidance and control system can accurately guide the munition to the target 20 for impact. If the target moves, the RF tagging system would transmit realtime positional data to the munition for increased accuracy during the terminal phase of the strike.

In an exemplary embodiment, the RF tagging system may be identified by a certain alpha numeric code and this code would be associated with the particular target. In the event that pre-standing orders exist for immediate termination of a target-type, the code may be immediately uploaded to an overhead asset which would then begin tracking the target and no further ground resources would be required to continue to track the target. The order to attack the selected target (along with the encoded alpha-numeric sequence of the tag) would be passed to the strike team which would then proceed immediately to the target location based upon the data being broadcast from the tag. The tag would then be ordered by the strike leader to begin immediate continuous broadcasting and a less expensive standoff GPS guided weapon would be selected for target termination. Additionally, if a strike asset was not available at the time, the target could be selected for destruction at anytime in the future provided the tag has sufficient power to broadcast (generally within 1 year). Pre-conflict tagging of targets also allows for rapid destruction of mobile targets within the first few hours of a conflict. In addition to decreased risk to valuable aircraft and aircrew, other resources are used more economically (i.e. jet fuel) due to quick mission turn around time and decreased need for air-to-air refueling.

It should further be appreciated that the RF tagging system is not limited to military applications. The RF tagging system 10 may be used in nonmilitary applications as such as police force tagging. For example, a policeman equipped with the RF tagging system 10 may shoot the RF tag using a 0.45 caliber weapon to tag a fleeing target. This is not limited to police but can be used in any application.

The foregoing embodiments and figures are presented by way of example only; the scope of the present invention is to be limited only by the following claims and the equivalents thereof.

1. A system for tagging and locating a target comprising:
a projectile frangible on impact;
a RF tagging system located in the projectile; and
a bonding agent located in the projectile.

2. The system of claim 1, wherein said RF tagging system comprises a RF circuitry, an antenna, and a power source.

3. The system of claim 2, wherein said RF circuitry comprises a circuit board, a processor, and a resonator.

4. The system of claim 1, wherein said antenna is a dipole antenna.

5. The system of claim 1, wherein said bonding agent comprises polybutene or polyisobutene.

6. The system of claim 1, wherein said projectile comprises a cover, wherein said cover forms a distal end of the projectile.

7. The system of claim 6, wherein said cover is plastic.

8. The system of claim 6, wherein said cover is scored to enable the cover to be frangible upon impact of the cover with the target.

9. The system of claim 6, wherein said cover comprises a substantially 0.45 caliber projectile.

10. The system of claim 1, wherein said RF tagging system comprises a reflective circuitry, wherein said reflective circuitry enables the RF tagging system to be selectively powered on and off.

11. The system of claim 10, wherein said RF tagging system is selectively powered on and off through the reflective circuitry using a radar transmission.

12. The system of claim 1 further comprising a GPS device for determining the location of the system.

13. The system of claim 12 wherein the location determined by the GPS device is transmitted through the antenna to a cellular phone tower for transmission to a cellular phone receiver.

14. The system of claim 1, wherein the RF tagging system is miniaturized.

15. The system of claim 1, wherein the RF tagging system transmits a signal to at least three cellular towers, wherein the signals transmitted to the at least three cellular towers are used to determine the location of the RF tagging system.

16. The system of claim 1, wherein said RF tagging system and bonding agent are delivered using a delivery device.

17. The system of claim 16, wherein said delivery device comprises a gun.

18. A method for tagging and locating a target comprising the steps of:
providing a RF tagging system;
providing a bonding agent for affixing the RF tagging system to the target; and
inserting the RF tagging system and the bonding agent into a projectile for transporting the RF tagging system and bonding agent.

19. The method of claim 18, wherein said RF tagging system comprises fu circuitry, an antenna, and a power source.

20. The method of claim 18 further comprising the step of providing a GPS receiver in the projectile for determining the location of the RF system when affixed to the target.

21. The method of claim 20 further comprising the step of transmitting the GPS location to a cellular tower such that the cellular tower transmits the GPS location to a desired cellular receiver.

22. The method of claim 21 further comprising the step of determining the location of the RF system through triangulation of cellular signal transmissions from the RF system to at least three cellular towers.

23. A system for tagging and locating a target comprising:
a RF tagging system, wherein the RF tagging system comprises RF circuitry, antenna, and power source;
a bonding agent for affixing the RF tagging system to the target;
a GPS receiver for determining the location of the RF tagging system; and
a projectile for containing and transporting the RF tagging system, bonding agent, and GPS receiver, wherein the projectile is frangible on impact.

24. A system for tagging and locating a target comprising:
a RF tagging system, wherein the RF tagging system comprises RF circuitry, antenna, and power source;
a bonding agent for affixing the RF tagging system to the target;
a GPS receiver for determining the location of the RF tagging system; and
a projectile for containing and transporting the RF tagging system, bonding agent, and GPS receiver, wherein the projectile is manually affixed to the target.
